(19) United States
(12) Patent Application Publication
(10) Pub. No.: US 2004/0059922 A1
(43) Pub. Date: Mar. 25, 2004

(54) Continuous voice recognition for user authentication by a digital transmitting device

(76) Inventors: Rodney C. Harris, Fort Collins, CO (US); Michael D. Erickson, Fort Collins, CO (US); Jeffrey S. Tiffan, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/251,355

(22) Filed: Sep. 20, 2002

(51) Int. Cl. H04L 9/00

(52) U.S. Cl. 713/186

(57) ABSTRACT

This invention relates to voice recognition for user authentication. Such structures of this type, generally, employ continuous voice authentication and a voice-based user interface for providing document destination and document format instructions when transmitting a document through the use of a digital transmitting device.

### FIELD OF THE INVENTION

This invention relates to voice recognition for user authentication. Such structures of this type, generally, employ continuous voice authentication and a voice-based user interface for providing document destination and document format instructions when transmitting a document through the use of a digital transmitting device.

### DESCRIPTION OF THE RELATED ART

Many peripherals to computer networks include a scanner component. One example of such a peripheral is an “All-in-one”, also known as a multi-functional product (MFP). A MFP has the capability to perform the multiple functions of scanning hardcopy documents, copying, printing or the like. Another example is a digital network copier that scans in documents from an automatic document feeder (ADF), does high volume copying, and has the capabilities of binding, collating, folding, stacking, stapling, stitching, edge-trimming, paginating, and printing on substrates of varied composition. Each of these peripherals, when in communication with an interconnecting network, can also be described as being a digital transmitter device.

The digital transmitter device is an appliance that has an input device, such as a keyboard, a display, and a scanner. The digital transmitter device need not have a printing device. It should be noted that a digital camera is also a type of digital transmitter device, but in comparison to the foregoing, it is not useful for handling documents and, typically, lacks the resolution and ability to rapidly and repetitively transfer information after scanning to a repository.

In an exemplary digital transmitting operation, a hardcopy of the document or other physical object can be presented to the scanner portion of a digital transmitter device. After scanning, a digital transmitter device transforms the scanned image into a digital representation that is then saved in a digital format, such as in a bitmap data format or in a Portable Document Format (PDF). Electronic messaging can be used to send an electronic mail (e-mail) from the digital transmitter device with an attachment of the digitized representation in the data format. The e-mail can be sent to recipients over an interconnecting network, where the recipients have an e-mail address that the user manually enters at the digital transmitter device or that a specific user specifies using a predefined list of recipient e-mail addresses that can be stored in the memory of the digital transmitter device.

Prior to the present invention, as set forth in general terms above and more specifically below, it is known, in the cellular telephone art, to employ voice commands. For example, the cellular telephone user can merely instruct the cellular telephone to automatically dial a desired telephone number. This technology is based upon the user previously giving a voice command, such as a codeword, to the cellular telephone. Commonly, the codeword is the first name of the person that belongs to that telephone number. The user then merely has to say the codeword into the cellular telephone and the cellular telephone automatically dials the phone number belonging to that codeword.

Typically, only the user's voice is recognized by the cellular telephone. However, if an unauthorized person is able to an enter a codeword into the cellular telephone then that other person will also be able to take advantage of the voice command capabilities of the cellular telephone. Therefore, a more advantageous system, then, would be presented if only authorized personnel were able to enter voice commands into the cellular telephone or other voice command recognition systems, such as digital transmitting device.

It is also known, in the user authentication art, to employ biometric measurements for the authentication of users to enterprise resources. Exemplary of such prior art is U.S. Pat. No. 6,256,737 ('737) to P. G. Bianco et al., entitled “System, Method and Computer Program Product for Allowing Access to Enterprise Resources Using Biometric Devices.” The '737 reference discloses the use of hand geometry, retina features, facial features, weight, DNA, breath characteristics, typing stroke, written signatures, and voice features when identifying a person. This information is used with public key information to grant a user access to enterprise resources. While the system disclosed in this reference is capable of identifying and authenticating a user, this system does not employ a continuous identification/authentication of the user. Also, this system does not provide for localized authentication based upon dialect. Therefore, a still more advantageous system, then, would be presented if the system would continuously identify/authenticate the user while taking into account the various dialects of the prospective users to be identified/authenticated. It is apparent from the above that there exists a need in the art for a system which allows an authorized user to enter voice commands into a digital transmitter, and which equals the voice command characteristics of the known voice command recognition systems, but which at the same time continuously identifies/authenticates the user while taking into account the various dialects of the prospective users to be identified/authenticated. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for using a digital transmitting device to authenticate a user, transmit a document, and carry-out post-processing instructions, wherein the method is comprised of the steps of: interacting with a digital transmitting device to set up a user authentication and a voice command recognition; scanning a document by the digital transmitting device; authenticating a user by the digital transmitting device; transmitting the document to a recipient; and carrying out the post-processing instructions. In certain preferred embodiments, the interacting step is further comprised of the steps of: preparing/entering the user identification for later authentication of the user through voice commands entered into the digital transmitting device; entering voice commands by the user regarding the contact information of the recipient and/or manually entering the contact information of the recipient; and entering voice commands by the user regarding any post-processing instructions for the document and/or manually entering any post-processing instructions for the document. Also, the contact information of the recipient can be, but is not limited to, e-mail address of the recipient, network address of the recipient, the telephone number of the recipient or the like. Also, the user authentication step comprises the step of comparing the actual user's voice recorded by the digital transmitting device with the previously stored voice for that user. Finally, the step of carrying out the post-processing instructions is further comprised of the step of forwarding the document to another location/device for further processing, such as a Web site or a server running an optical character recognition (OCR) system or an archival application. Also, the post-processing instructions can be, but are not limited to, forwarding the document to a web page, forwarding the document to an archival application, binding, collating, folding, stacking, stapling, stitching, edge-trimming, paginating, printing on substrates of varied composition for further image transforms, re-transmission after transform, file format translations or the like.

In another further preferred embodiment, a user's voice is recorded and stored by a digital transmitting device to provide continuous authentication of the user, enable a document to be forwarded to a desired recipient, and provide instructions regarding any post-processing of the document.

The preferred user identification/authentication system, according to this invention, offers the following advantages: ease-of-use in a digital transmitting device; excellent user identification characteristics; excellent user authentication characteristics; ability to adapt to various dialects of the prospective users; continuous user identification; continuous user authentication; and excellent economy. In fact, in many of the preferred embodiments, these factors of ease-of-use in a digital transmitting device, excellent user identification characteristics, excellent user authentication characteristics, ability to adapt to various dialects of the prospective users, continuous user identification, and continuous user authentication are optimized to an extent that is considerably higher than heretofore achieved in prior, known user identification/authentication systems.

The above and other features of the present invention, which will become more apparent as the description proceeds, are best understood by considering the following detailed description in conjunction with the accompanying drawing FIGURE and in which:

### BRIEF DESCRIPTION OF THE DRAWING

The FIGURE is a flowchart that illustrates a method for continuous user identification/authentication, according to one embodiment of the present invention.

### DETAILED DESCRIPTION OF THE INVENTION

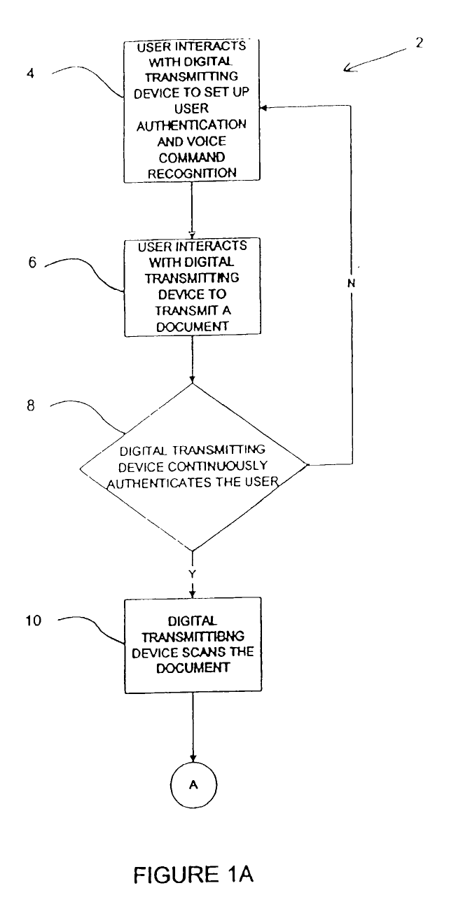

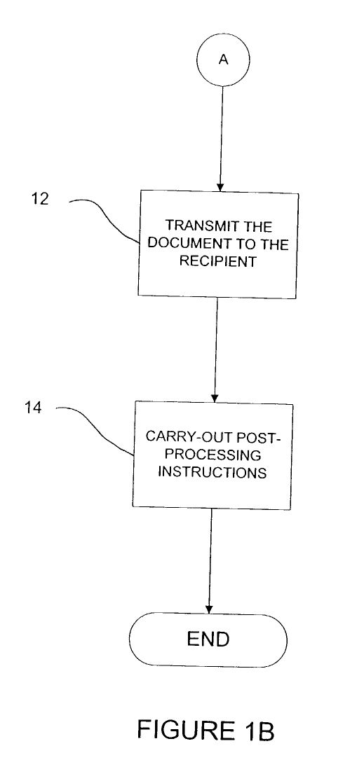

With reference to FIGS. 1A and 1B, there is illustrated one preferred embodiment for use of the concepts of this invention. FIGS. 1A and 1B illustrate method 2 for using a digital transmitting device for user authentication, document auto-routing, and document post-processing. Method 2 includes, in part, the steps of: having the user interact with a digital transmitting device to set up the user authentication and voice command recognition (step 4); having the user interact with the digital transmitting device to transmit a document (step 6); having the digital transmitting device continuously authenticate the user (step 8); scanning the document through the digital transmitting device (step 10); transmitting the document to the desired recipient (step 12); and carrying out any post-processing instructions (step 14).

With respect to step 4, the user's voice recognition pattern is conventionally stored in the digital transmitting device for later authentication of the user. Also, the user can store voice commands for later recognition by the digital transmitting device, such as document format instructions or personal settings for the digital transmitting device and/or the recipient's media handling device. It does not matter whether these commands are commonly accepted words or personal words. For example, the user could use the word “staple” in the appropriate language and/or dialect to have a document stapled in post-processing or the user could use any made-up sound or word, like “Zambeze-underground” to imply stapling. The ability to use any made-up sound or word would have advantages in accessibility for a speech-impaired user. The “personal word” could even possibly involve tapping, or humming, or breath-patterns, etc. For example, the user may request that all documents to be printed by the digital transmitting device be duplexed. Also, the user may specify that only a certain type of media, such as transparencies, can be used by the recipient's media handling device. Also, the user could store a variety of voice commands related to various recipients. For example, the user could store a codeword that is related to a particular recipient. Finally, it is to be understood that the user's voice recognition pattern can be localized based upon the dialect of the user.

Finally, it is to be understood that the voice recognition/voice command data of the user can be stored off-line from the digital transmitting device, such as in a database that is conventionally accessible to the digital transmitting device.

It is to be understood that a first time user could stop after step 4 and then come back later and begin with step 6. This also applies to other users who have set up their user authentication and voice recognition in the digital transmitting device.

With respect to step 6, the user interacts with a digital transmitting device to transmit a document. In this step, the user, preferably, enters voice command information into the digital transmitting device regarding a destination of the recipient of the document, any document format instructions, and, if necessary, any document post-processing instructions. For example, the user may state the name, company name, address, telephone number, and facsimile number of the desired recipient. It is the understood that the user could also employ a codeword to identify the recipient and the destination of the recipient. The user may, for example, also state that the user wants the document to be duplexed and have a copy downloaded to the user's Web site.

It is to be further understood that the user can also state the email address of the recipient, the network address of the recipient or the like, depending upon the type of media handling devices the recipient desires to receive the document upon. It is to be even further understood that a conventional document could be printed by the digital transmitting device such that the document acts as a receipt for the user.

With respect to step 8, while the user is giving actual voice commands to the digital transmitting device, the digital transmitting device is continuously, conventionally comparing the actual voice commands of the current user with the stored voice recognition pattern of that particular user to continuously authenticate the user.

It is to be understood that the term “authenticate” can be used in a variety of ways. For example, if only a particular user is allowed to use the digital transmitting device, this method would assure that only the particular user was using the digital transmitting device. Also, it may be desired that only a particular recipient may receive documents from the user. Again, this system would assure that result. Finally, authenticating the user also prevents an unauthorized user from sending a document in someone else's name.

It is also to be understood that the term “continuously” could mean every time the user speaks to command the digital transmitter, a voice recognition and authentication analysis is performed. Alternately, the frequency of authentication analysis could be less than 100%, instead set at some level that constitutes “adequate” security. In addition, this could be configurable by the network administrator for the particular installation.

Non-continuous could be defined as a frequency of authentication that correlates to standard practice in a typical network-computing environment. For example, logging in once per day or once per week on a PC or at every time a user accesses the top level of a secure Web-site, but only the top level.

To carry this further, for example, in the fullest extent of “continuously”, a user could be asked to enter a password at every Web-page accessed, which would be frustrating for the user and it would not work. Whereas in voice authentication, a continuous authentication, done every step of the way, would be transparent to a user if it were quickly done.

If the digital transmitting device does not recognize/authenticate the user, a notice can be sent to the user, and if so configured, to the system administrator. For example, a message can be made to appear on the graphical user interface (GUI) of the digital transmitting device informing the user that the user is not authorized to use the digital transmitting device. It is to be understood that other conventional forms of notification can be sent to the user informing the user that the user has not been authenticated or that the user is not authorized to use the digital transmitting device. Once the user has been notified that it is not authorized to use the digital transmitting device, the unauthorized user may have to contact the system administrator, whereupon the system administrator may inform the unauthorized user to proceed to step 4 (FIG. 1A), so that the unauthorized user can set up his/her own user authentication and voice command recognition.

It is to be understood that the user could merely walk up to the digital transmitting device, enter a user specific password or other such identifier into the GUI of the digital transmitting device in order to have the digital transmitting device transmit a document. The user can then proceed, as described above, in utilizing the digital transmitting device.

With respect to step 10, the document is conventionally scanned by the digital transmitting device. It is to be understood that prior to the document being scanned by the digital transmitting device, the digital transmitting device utilizes a conventional voice recognition system to recognize the voice commands of the user.

With respect to step 12, the scanned document is conventionally forwarded to the desired recipient.

With respect to step 14, the post-processing instructions, if any, are carried out upon the document on the destination device, as discussed above.

With respect to post-processing instructions, these refer to instructing the digital transmitting device as to how the workflow system handles this document. For example, the user may decide to forward the document to a Web site so that the document will be put into a web page. The user can, preferably, enter information, such as a network address that instructs the digital transmitting device to scan the document and forward the scanned document to a category in the web page. Also, the user can instruct the digital transmitting device to perform such post-processing as binding, collating, folding, stacking, stapling, stitching, edge-trimming, paginating, and printing on substrates of varied composition.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for using a digital transmitting device to authenticate a user, transmit a document, and carry-out post-processing instructions, comprising the steps of:
interacting with a digital transmitting device to set up a user authentication and a voice command recognition;
scanning a document by the digital transmitting device;
authenticating a user by the digital transmitting device;
transmitting the document to a recipient; and
carrying out the post-processing instructions.

2. The method, as in claim 1, wherein said interacting step is further comprised of the step of:
storing a voice recognition pattern of said user in said digital transmitting device.

3. The method, as in claim 2, wherein said interacting step is further comprised of the step of:
storing voice commands of said user in said digital transmitting device based upon said voice recognition pattern of said user.

4. The method, as in claim 1, wherein said interacting step is further comprised of the step of:
storing a voice recognition pattern of said user in a database.

5. The method, as in claim 4, wherein said interacting step is further comprised of the step of:
storing voice commands of said user in said database based upon said voice recognition pattern of said user.

6. The method, as in claim 2, wherein said interacting step is further comprised of the step of:
entering an actual voice command by said user into said digital transmitting device.

7. The method, as in claim 6, wherein said authentication step is further comprised of the step of:
comparing said actual user voice command with said stored user voice command.

8. The method, as in claim 4, wherein said interacting step is further comprised of the step of:
entering an actual voice command by said user into said digital transmitting device.

9. The method, as in claim 8, wherein said authentication step is further comprised of the step of:
comparing said actual user voice command with said stored user voice command.

10. The method, as in claim 1, wherein said step of carrying out said post-processing instructions is further comprised of the step of:
forwarding said document to a Web site.

11. The method, as in claim 1, wherein said step of carrying out said post-processing instructions is further comprised of the step of:
forwarding said document to a server running on an optical character recognition application.

12. A program storage medium readable by computer, tangibly embodying a program of instructions executable by said computer to perform the method steps for using a digital transmitting device to authenticate a user, transmit a document, and carry-out post-processing instructions, comprising the steps of:
interacting with a digital transmitting device to set up a user authentication and a voice command recognition;
scanning a document by the digital transmitting device;
authenticating a user by the digital transmitting device;
transmitting the document to a recipient; and
carrying out the post-processing instructions.

13. The method, as in claim 12, wherein said interacting step is further comprised of the step of:
storing a voice recognition pattern of said user in said digital transmitting device.

14. The method, as in claim 13, wherein said interacting step is further comprised of the step of:
storing voice commands of said user in said digital transmitting device based upon said voice recognition pattern of said user.

15. The method, as in claim 13, wherein said interacting step is further comprised of the step of:
entering an actual voice command by said user into said digital transmitting device.

16. The method, as in claim 15, wherein said authentication step is further comprised of the step of:
comparing said actual user voice command with said stored user voice command.

17. The method, as in claim 12, wherein said step of carrying out said post-processing instructions is further comprised of the step of:
forwarding said document to a Web site.

18. The method, as in claim 12, wherein said step of carrying out said post-processing instructions is further comprised of the step of:
forwarding said document to a server running on an optical character recognition application.
